(19) United States
(12) Patent Application Publication
(10) Pub. No.: US 2008/0271165 A1
(43) Pub. Date: Oct. 30, 2008

(54) PARAMETER-BASED INTERPRETATION OF DRM LICENSE POLICY

(75) Inventors: Torbjorn Patrik Gustaf Schnell, Issaquah, WA (US); Scott Lee Davis, Redmond, WA (US); Troy David Batterberry, Seattle, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/741,679

(22) Filed: Apr. 27, 2007

(51) Int. Cl. H04L 9/32

(52) U.S. Cl. 726/30

(57) ABSTRACT

To enforce content access restrictions, a license associated with protected content is generated. This license may have at least one evolving parameter. That is, the parameter value may change; e.g., depending upon content access, copying, etc. For example, each successive generation of a license may have an incremented value in an evolving “generation” parameter. The license may also have evolving rules that describe different content access rules for different values in the evolving parameter

### COPYRIGHT AUTHORIZATION

A portion of the disclosure of this patent document contains material which is subject to copyright protection. The copyright owner has no objection to the facsimile reproduction by any one of the patent disclosure, as it appears in the United States Patent and Trademark Office patent files or records, but otherwise reserves all copyright rights whatsoever.

### BACKGROUND

Unlike analog content of days past, digital content (such as movies, music, maps, games, and so forth) can be copied very easily. Further, each subsequent copy is, often, the same quality as the original. Copyright holders of such easily-copyable digital content are understandably interested in ways to keep their material from being used and distributed without permission. Thus, Digital Rights Management (DRM) systems have been developed to prevent unauthorized copying and other illicit forms of digital content access.

DRM systems typically allow a user to only access content for which a license has been acquired. Such licenses often include restrictions on use, which are interpreted by the DRM systems to allow or disallow access. For example, a user may be able to play a licensed song an unlimited number of times on the device on which the content was originally downloaded, but may not be able to copy the content to a different device.

DRM systems may also allow users to share purchased content within certain restrictions. This could be done, for example to allow people to preview new content to see if they like it prior to purchase. For example, a user could download a song to a friend's device for free, but the friend would only be able to access the song for three plays or for three days, whichever happens first.

However, when the restrictions for content access include stateful information (i.e. the number of times the content has been played, how many times the content has been copied, etc.), it is difficult to define a rule on how to propagate the state to a new device when the content and the license are copied to the new device. In addition, there might be different license restrictions for a derived license (i.e., for a copied version of the content) than from the directly acquired (originally downloaded) license.

### SUMMARY

In an exemplary embodiment, when a user purchases or otherwise obtains content, a license is created for the content which has one or more updatable evolving parameters, i.e., parameters with updatable values. As an example, a parameter may be “generation,” indicating the number of times that the content had been copied. This license, when created, is signed by the issuing service (e.g., using strong cryptography). As the content is consumed, the parameter(s) associated with the license are updated. These parameters may be in the license or may be stored within a DRM system associated with the content, e.g., on which the content resides.

The license may have evolving content access restrictions associated with the parameters based on the parameter values. Such evolving restrictions may be stored in the license or stored on a system, such as a DRM system, associated with a device that holds the content. The restrictions may be interpreted differently for different parameter values. That is, the restrictions allow the content access to evolve based on access policy. Further, different systems may interpret the same restrictions differently, e.g., the policy may change, and the interpretation of the restrictions (though not the restrictions themselves) may also change to implement the new policy.

As an example, the parameter restrictions for an evolving parameter “generation” can give the restrictions for when associated content can be accessed, and the types of access that are allowed, based on the value of the “generation” parameter. For example, a user may purchase rights to a song; e.g., the user may listen to a song unlimited times on a first device, and may download from the first device to another device; e.g., a first generation download. That is, the song may be downloaded from the original device to other target devices, but those devices may not copy the song to any other devices. The evolving rules, in such a case, may state that when the generation parameter value (associated with the license) has the value, e.g., “1”, indicating a first generation license, the content (and its license) may be copied. When the generation value is, e.g., “2” or greater, indicating a second generation or higher copy, the content may not be copied.

When the content is to be copied to the target device, a license derived from that on the original device may be sent to the new device. This derived license may have an evolving parameter whose value has been modified or updated from that in the original license indicating that a state value associated with the license has changed. For example, a “generation” parameter may have its value modified indicating that that this is a second generation copy of the content.

Consequently, a device can treat the same content differently depending on context without having to have the restrictions hard-coded on the device. Continuing with the above example, the license restrictions may indicate that copies cannot be made from second generation content. Thus, a user at the target device whose license has the generation value, e.g., 2, indicating a derived license, would be unable to copy the content onto another device. Thus, the restrictions of how the content can be accessed appear to evolve as the license propagates through different devices. When a user wishes to access the content associated with the license, the license is first located, then the parameter values are read from the license to determine if access is allowed. If so, then the content is, e.g., decrypted, and accessed. Access may comprise reading the content, transferring the content to a different device (e.g., copying or synching), playing the content, and so on.

Thus at the device level, restrictions on content appear to evolve for as the content and its license propagates.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram illustrating an exemplary computing environment for implementing parameterized licenses for digital rights management as taught herein.

FIG. 2 is a flow diagram illustrating an exemplary prior art method for a client receiving and using a license and content from a server.

FIG. 3 is a flow diagram illustrating an exemplary method for a creating and applying parameterized license restrictions.

FIG. 4 is a block diagram illustrating an exemplary license with parameterized values and evolving restrictions.

FIG. 5 is a flow diagram illustrating an exemplary method for a creating a license with parameterized values and restrictions.

FIG. 6 is a flow diagram illustrating a path that a license and optional associated content can take when being copied between devices.

FIG. 7 is a flow diagram illustrating a method by which a source supplies a user with a parameterized license and optional associated content.

FIG. 8 is a flow diagram illustrating a method by which a device uses a parameterized license.

FIG. 9 is a block diagram illustrating an exemplary device comprising content and an associated license with parameterized values modules for utilizing said license.

FIG. 10 is a flow diagram illustrating a method to determine if content has access rights when there is a complex chain of licenses affecting the rights.

### DETAILED DESCRIPTION

### EXAMPLE 1

### Exemplary Computing Environment

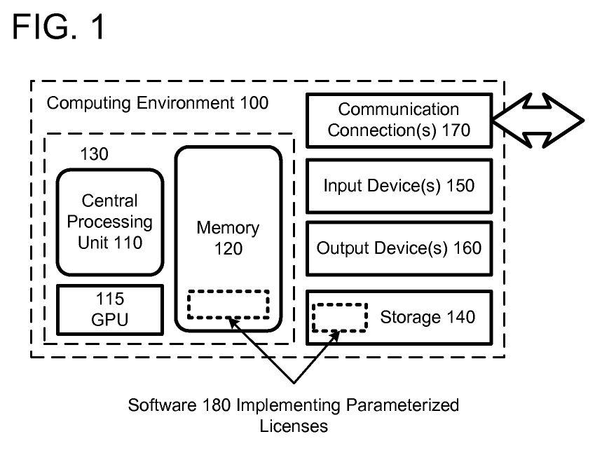

FIG. 1 and the following discussion are intended to provide a brief, general description of an exemplary computing environment in which the disclosed technology may be implemented. Although not required, the disclosed technology can be implemented with computer-executable instructions being executed by a computer such as a personal computer (PC), a portable musical device, or other computing device such as those found in hand-held devices such as TV remote controllers, cell phones, and the like. Generally, program modules include routines, programs, objects, components, data structures, etc., that perform particular tasks or implement particular abstract data types. Moreover, the disclosed technology may be implemented with other computer system configurations, including multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

FIG. 1 illustrates a generalized example of a suitable computing environment 100 in which described embodiments may be implemented. The computing environment 100 is not intended to suggest any limitation as to scope of use or functionality of the technology, as the present technology may be implemented in diverse general-purpose or special-purpose computing environments.

With reference to FIG. 1, the computing environment 100 includes at least one central processing unit 110 and memory 120. In FIG. 1, this most basic configuration 130 is included within a dashed line. The central processing unit 110 executes computer-executable instructions and may be a real or a virtual processor. In a multi-processing system, multiple processing units execute computer-executable instructions to increase processing power and as such, multiple processors can be running simultaneously. The computing environment 100 may also include a graphics processing unit (GPU) 115, which assists in creating or speeding up graphics processing and display. Memory 120 may be volatile memory (e.g., registers, cache, RAM), non-volatile memory (e.g., ROM, EEPROM, flash memory, etc.), or some combination of the two. The memory 120 stores software 180 implementing the described methods for implementing parameterized licenses for digital rights management. A computing environment may have additional features. For example, the computing environment 100 includes storage 140, one or more input devices 150, one or more output devices 160, and one or more communication connections 170. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

The storage 140 may be removable or non-removable, and includes magnetic disks, magnetic tapes or cassettes, CD-ROMs, CD-RWs, DVDs, or any other medium which can be used to store information and which can be accessed within the computing environment 100. The storage 140 may store instructions for the software 180 implementing the described methods for implementing parameterized licenses for digital rights management.

The input device(s) 150 may be a touch input device, such as a keyboard, mouse, pen, or trackball, a voice input device, a scanning device, or another device, that provides input to the computing environment 100 such as a gaming pad, a joystick, a dance pad, or a nonstandard device such as one or more multidirectional input devices working together used for character input. For audio, the input device(s) 150 may be a sound card or similar device that accepts audio input in analog or digital form, or a CD-ROM reader that provides audio samples to the computing environment 100. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, compressed graphics information, or other data in a modulated data signal.

Computer-readable media are any available media that can be accessed within a computing environment 100. By way of example, and not limitation, with the computing environment 100, computer-readable media include memory 120, storage 140, communication media (not shown), and combinations of any of the above.

### EXAMPLE 2

### Definitions

The technologies described herein can be used in any of a variety of scenarios in which licensing digital content is useful. For example, the implementations taught herein can be used to allow content to have different usage restrictions on different devices.

Content refers to digitally encoded works, such as music, movies, television shows, games, digital photographs, books, software, object code, ringtones, wallpaper, maps, etc.

A Service provider is the provider of the content to the user. Examples include digital music stores such as Napster, Apple iTunes store, and Microsoft's Zune, as well as audioblogs (or music blogs) which distribute music, sometimes directly from an artist.

A contentprovider is an originator of the digital media. Examples include individual authors, movie studios, recording companies, book publishers, and the like. Content providers (such as a record company) gives a service provider (such as Zune) the right to use the content under certain restrictions. The content can then be distributed to end users. In some instances, the content provider and the service provider may be the same entity, as in the case of artists who sell their work from dedicated websites.

A device is a computer enabled system that is suitable for implementing digital rights such as a portable audio and/or video player, a mobile phone, a consumer electronics device, a digital media receiver, a set-top box, a CD player, a DVD player, a personal computer (PC), a laptop computer, a PDA, a BlackBerry, and so on.

Policy refers to DRM rights and DRM restrictions. DRM rights (e.g. Play, Bum, Copy, PlayGame, Export) give permissions for certain actions associated with a given piece of content. These permissions are generally encoded in a license and/or can be defined in rules, such as conformance rules, associated with the device with which the content is located. DRM restrictions (e.g., PlayCount, BumCount, Expiration, SecurityLevel) give, in certain embodiments, the number of times certain actions are allowed. For example, if PlayCount has the value, e.g., “4”, the given content may be played four times. Generally, a right within a policy can have multiple restrictions associated with it.

A license is a legal grant to use content. A license may be valid for a specific time, may allow the content to be played a given number of times, may set a duration for play time, may allow the license holder to make a specified number of copies, and so forth. Content which requires a license to play may be called “protected content.” The license may be associated with a device. In some embodiments, the device may be allowed to copy the license to another device, with appropriate modifications to the license. A fee may be used to purchase a set number of uses (for example, one) of a license. A royalty may be used to pay for ongoing use of a license. More than one license may be associated with a single item of content. The content and the license can be distributed separately.

Digital Rights Management (DRM) systems are systems which restrict access to content on a computing device. These systems may be implemented in software, in firmware, or in hardware, or in a combination of them. Often cryptographic controls are used to limit access to content. Content is often given permission to run on a DRM system through the use of a license. The license may be associated with a device, or may be associated with a chain of devices, e.g., a first device may transfer the license and content to a second device. The DRM system may keep state information about content, such as the number of times a piece of content has been played, the number of times the content has been copied, etc., within the DRM system itself.

A license acquisition server (or license server) is a server which provides the original version of licenses to devices. The server may access a license database to determine which rights a given user may have in association with specific content.

Evolving policy is a policy that is interpreted differently depending on the value of evolving parameters, such as “generation” or “source” in the license in which it is encoded. For example, if, e.g., the “generation” value in a license is 1, indicating that this is the original license (e.g., the content was not copied once it was initially received) the policy may permit copying. However, if the “generation” value in the license is greater than 2, indicating that the content has been copied since receipt, the policy may not permit copying. Note that this does not necessarily mean the encoding of the evolving policy within a license must change in subsequent generations of the license. Indeed, certain embodiments support having identical encoding of a policy in every generation license. In some embodiments, the policy restrictions that are interpreted differently based on the value of an evolving parameter are encoded in a license associated with specific content and are called evolving restrictions. Alternatively, the evolving policy can be codified somewhere other than the license, such as compliance rules, and enforced through logic built in to the PC or device applications.

### EXAMPLE 3

### Exemplary Prior Art System

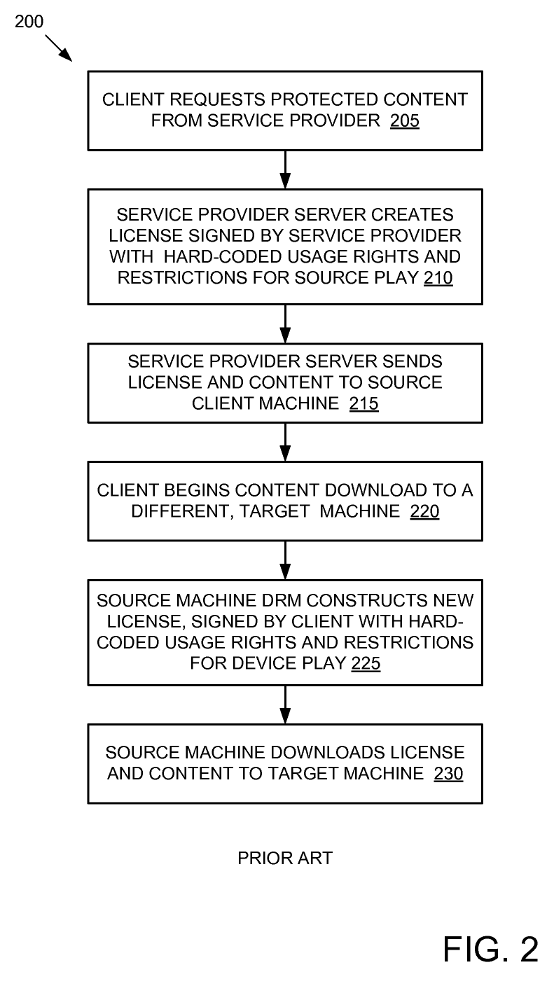

Digital Rights Management systems protect copyright holders by restricting digital license holders to only the rights for which they have paid. Content providers (such as a record company) give service providers (such as Zune) the right to use the content under certain restrictions. The content can then be distributed to end users. For example, a user may purchase a license that allows a user to listen to a song twice. FIG. 2 shows a prior art system 200 for enforcing such licensing restrictions. At 205, a client (or user) requests protected content from the service provider. The client may choose the terms of the license, or the terms may be set by the service provider. At 210, a license acquisition server at the service provider creates a first-generation license for the content with hard-coded rights and restrictions for how the content can be played. That is, the restrictions in the license cannot be modified. The license is signed by the service provider, often in such a way that it is very difficult to tamper with. Once the first-generation license has been created, if not otherwise restricted, other devices may create copies of this license or derive new versions of the original license.

At 215, the license acquisition server then downloads the content and the license onto the user's device. However, now at 220, the user copies the song to a different, target device. Currently, well-known DRM systems must issue separate licenses for specific devices. As such the user's original device now constructs a new license 225, which it then sends to the target device, along with the content at 230. The new license 225 is a copy of the old license with the same hard-coded rights and restrictions, except that it is signed by the client, rather than the service provider, and so may be more susceptible to tampering.

Furthermore, the same license was passed from the original device to the target device, giving the target device the same rights as the old device. That is, the target device will also allow the song to be played twice, giving the user four plays of the song, rather than the two intended by the licensing agency. If, after the song is played once, a copy is made to a target device, as a copy of the original license will be sent to the target machine, the target device will still be allowed to play the song twice. Thus, each device is given two plays, for a total of four song plays; not what the content owners intended when the license was acquired.

### EXAMPLE 4

### Overview

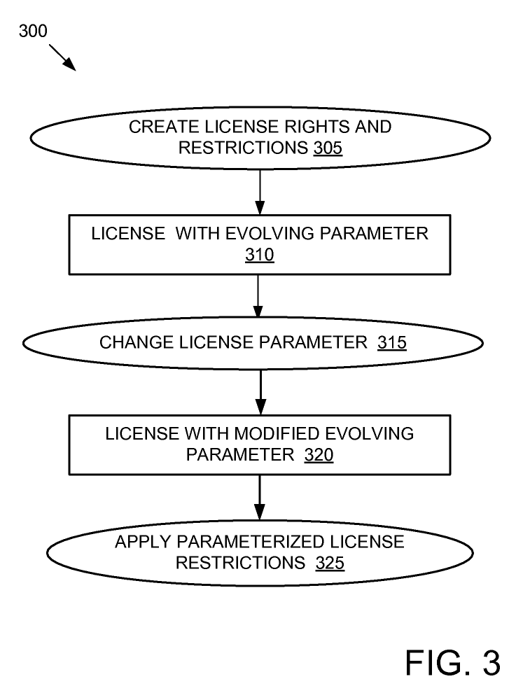

FIG. 3 shows an exemplary system 300 for using parameterized licenses to protect digital content. At 305, a license with content rights and restrictions (which may include parameterized restrictions) is created. A parameterized restriction is a restriction associated with a parameter within the license whose interpretation may change with use.

Typically, a content provider, such as an artist, and a service provider will come to agreement as to licensing terms; that is, how much a content license (such as rights to play a song on a device) will cost; how long the license will be good for, and so on. Some license restrictions are: expiration time; play count; that is, the number of times the a game, a movie, or a song can be played; burn count, that is, number of times a given piece of content may be burned to disk; metered play; that is, the total amount of time for which the content may be accessed; expiration date; e.g., the date the content can no longer be accessed, and so forth. Generally, any content permission request can have specific licensing restrictions.

Other types of restrictions allow different generations of the content to be treated in different ways. For example, license terms could be such that the first generation copy (e.g., in some embodiments, the copy downloaded initially from the license acquisition server) has unlimited play rights and copy rights. However, a second generation copy (that is, a copy made by the first generation copy or a sync from the first generation copy) could only allow a limited number of plays and no copies.

At 310, these restrictions are codified, such that there may be different restrictions for different parameter values, such as different restrictions for different generation copies. For, example, an evolving parameter may be created in the license whose value may change depending on content access, and/or whose interpretation may change. The value may change depending on content behavior. For example, a “generation” parameter may indicate which generation of the license is at a given device; in such a case a “generation” parameter (or the like) would be updated for each subsequent generation of the license.

In some embodiments, these restrictions are coded into the license. In other embodiments, the rules are defined in compliance rules associated with the device. Some restrictions require that states relating to the license be kept on the device that the license will be sent to, such as within the device's DRM system. For example, the number of times that a given song (content associated with the license) has been played may be stored in a state variable, e.g., PlayCount, located in the DRM system within the device.

The interpretation may change, for example, if a restriction is encoded into a license that is then sent to a first device which cannot interpret the restriction. The restriction will, in some embodiments, be ignored. However, if the first device then sends the license to a second device which can interpret the restriction, the restriction will be followed.

When a user acquires content from a service provider, a license associated with the content is sent to a source device. In some implementations, the license may be bundled with the content. In other implementations, the content may be already present on a source device when the license is sent. In yet other implementations, the content, while not present on the source device, is accessible to the source device. At the source device, an associated DRM system (or similar system) reads the license and decrypts (or otherwise grants access to) the content. The content is then acted on by the source device. For example, a song may be listened to, a level of a game played, or a movie may be watched.

At 315, at least one parameter variable within the license is changed. In some embodiments, the policy encoded in or interpreted using the license never changes. However, an evolving parameter, such as the “generation” parameter may have its value changed when, e.g., a new generation of the license is generated, when, for example, the content associated with the device is copied. A device with a license with the evolving parameter value will then interpret the policy differently depending upon the value in the evolving parameter. Thus, for a policy that only allows first generation copies, content with an evolving parameter, e.g., “generation” in its associated license that indicates that this is a first generation of the content may be allowed to be copied, while content on the same device with a “generation” parameter in its associated license indicating that this is a second generation copy of the content may not be copied.

The license with evolving parameter-based policy is shown at 320. At 325, the restrictions for content consumption are interpreted using the new evolving parameter value. The next time the content (such as a movie) is accessed, the DRM system (or a similar system) checks the restrictions for the content. These restrictions may be encoded in the license, encoded within a contract of compliance rules associated with the device, hardcoded on the device, or may be implemented using a combination of the options, and so on. In some systems, the restrictions may be evolving, that is, the restrictions may change during the life of the device.

In one such case, a license contains restrictions that may be downloaded to a device from a server such as a license acquisition server. In some devices, the restrictions may not be understood. In such a case, the restrictions may be ignored by the device; that is, the behavior of the device will not change. However, if a device that doesn't understand the restrictions within a license sends a copy of the license including those restrictions that it doesn't understand to a different device which does understand the restrictions in the license, those new restrictions will be followed by that device.

Even though the evolving restrictions have not changed, a device may treat content associated with those restrictions differently based on the evolving parameter. For example, the original compliance rules as understood by a device may allow copying with a first or second generation license, while new compliance rules may allow copying only with a first generation license.

### EXAMPLE 5

### Exemplary License

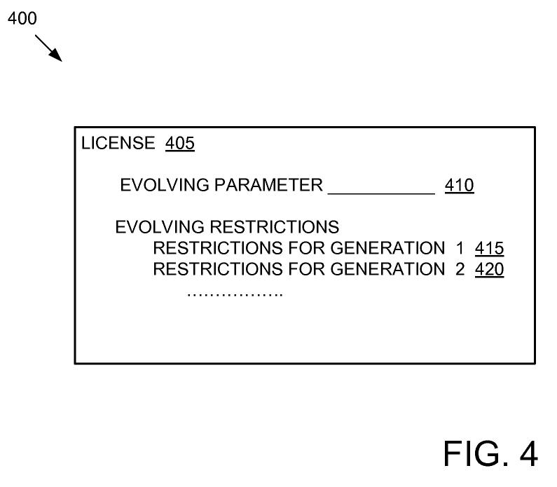

FIG. 4 at 400 shows an exemplary license that can be used when implementing parameter-based policy licenses for digital rights management. The license 405 can have an evolving restriction whose interpretation changes depending on the value of an evolving parameter. For example, a song could be sold that is allowed to be copied from the device that initially downloaded the song to a second device. However, the second device cannot copy the song onto a third device. To implement such a scheme, the license could have an evolving parameter, e.g., “generation” 410, that would be updated in each successive copy of the license.

The license could then also have evolving restrictions 415, 420 that describe the actions allowed for valid values of the, e.g., “generation” variable. In an embodiment, the evolving restriction 415 for generation value equal to “1” 410 may be “allow copy,” while the restriction for generations greater than or equal to “2” 420 may be “do not allow copy.” Thus, the evolving restrictions 415, 420 in every copy of the license remains the same, while the behavior of the content associated with the license changes depending on the value in the evolving parameter. Content with a first generation license (e.g., the “generation” value equal to, e.g., “1”) would allow the content to be copied. However, content with a second generation license (e.g., the “generation” value equal to, e.g., “2”) would not allow the content to be copied.

In another example, the evolving restrictions may be that if this is a first generation license, then unlimited plays are allowed, while if this is a second generation license or higher, then a restricted number, e.g., “3”, plays are allowed. Thus, a device receiving a first generation copy of the license would allow unlimited plays, while a device receiving a third-generation copy of the license (as reflected in, e.g., a “generation” parameter within the license) would only allow the content to be played three times. The number of times the content has been played may be stored in a state variable in the DRM system associated with the device on which the content is accessed.

In some implementations, an evolving parameter, such as the “generation” value is initially set to a value indicating that this is a first generation license, e.g., and without limitation, “1” when the license 405 is initially downloaded.

In another exemplary embodiment, the restriction parameters (e.g., the parameters 415 and 420) are not in the license. Rather, the restrictions are codified at the device level, i.e., the device has internal restrictions that determine behavior for different values of the evolving parameter. For example, the device may have restrictions (which may be hardcoded) forbidding creating copies of the content if, e.g., the “generation” parameter is above a certain value, such as, e.g., “3.”

### EXAMPLE 6

### Exemplary Method to Use Parameterized Licenses

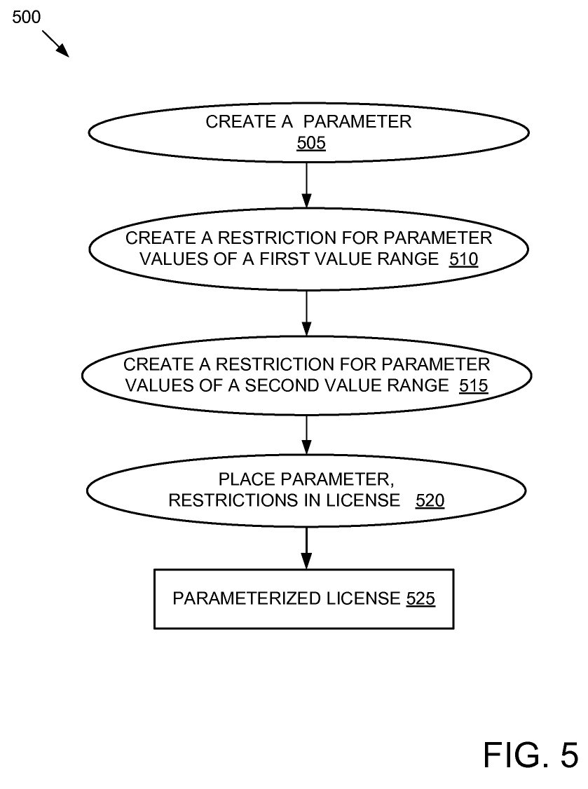

FIG. 5 at 500 shows an exemplary method to create a parameterized license, such as the license 400 in FIG. 4. At process block 505, a location which will hold an updatable evolving parameter value is created. The field 410 (FIG. 4) is an example of such an evolving parameter value location. Other exemplary parameters may include those that store values associated with content restriction states such as number of allowed plays, burns, counts, copies, exports, playlists, the type of device that copied the license for the content, and so on. The value may be initialized.

At optional process block 510, an evolving restriction based on the evolving parameter, e.g, the value in the parameter, is created for a first value range. For example, a license may have the restriction: if the generation value is one, copies may be made. At optional process block 515, another evolving restriction for using the parameter value is created for a second value range. For example, a license may have the restriction that if a generation value is greater than one, copies may not be made. In certain embodiments, the same restriction may be able to be interpreted differently for different values of the given parameter. At process block 520, the evolving parameter and the evolving restriction(s) (if included) are placed in the license. Alternatively, a license may be created with the updatable value 505 but without the restrictions 510, 515 stored in the license. This creates a parameterized license 525.

### EXAMPLE 7

### Exemplary License Path

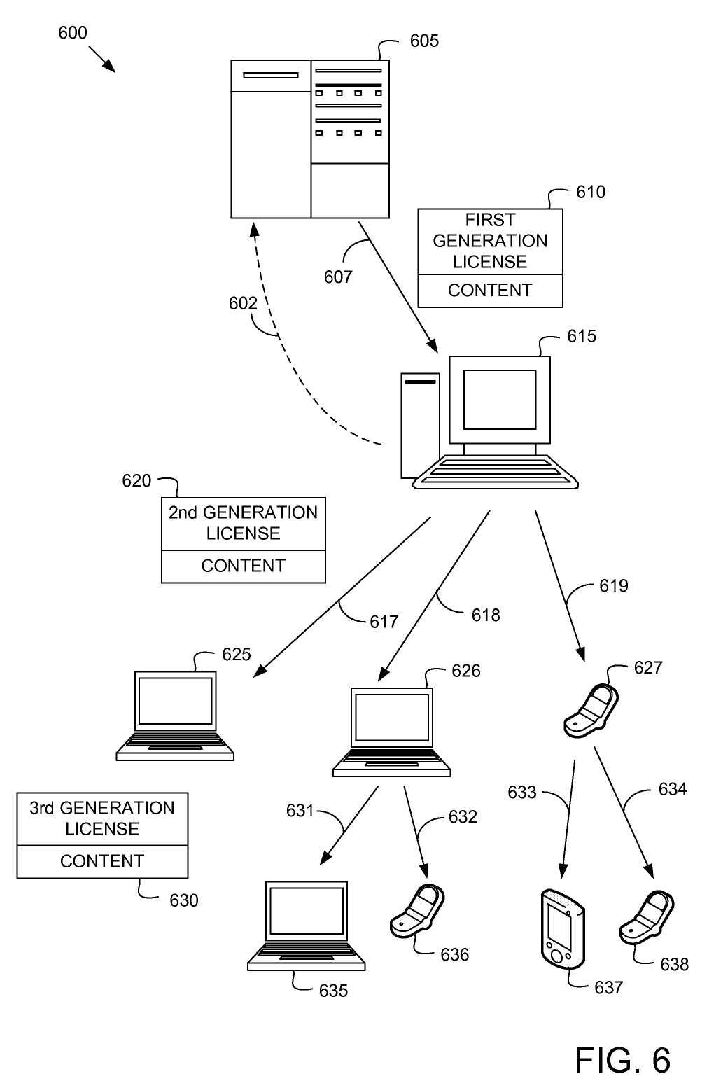

FIG. 6 at 600 shows an exemplary path that a license with evolving restrictions can take when copied. At 602, a user at a computer 615 requests content, such as a song, from a license acquisition server 605. The license acquisition server 605 creates a first generation license 610 for the content, including restrictions followed when transferring the content, such as those described with reference to FIG. 4. For example, a license 405 (FIG. 4) may be created with an evolving parameter 410, such as an e.g., “generation” parameter. The license acquisition server 605 then sends 607 the license 610 and the content to the user's source device, such as a computer 615. In some embodiments, the license only is sent from the license acquisition server 605 to the user's computer 615. The content may already be residing on the user's computer or may be downloaded from a location different than the server computer 605.

The user at the source computer 615 may then decide to copy the content to one or more different devices 625, 626, 627 such as a laptop, cell phone, or portable media player. The process of copying the content may include transferring the license 610. The license transferred is a derived copy 620 of the same license 610 that was originally created by the server 605, and contains the same values for the evolving restriction but may change the value of the evolving parameter. For example, if the license has a “generation” evolving parameter, if the first generation license has the value of, e.g., “1”, to indicate that this is a first generation license, the copied license 620 will be updated to reflect the information that it is a copy and will so have an updated value, e.g., “2”, placed in its “generation” evolving parameter to indicate that this license is for second generation content. Generally, the actual update value need not be an increment (or a decrement) or even an integer. It just needs to be a value that can be understood in terms of restrictions on content access, as previously discussed. When the source computer creates a copy, even for different devices other than 625, the, e.g., “generation” parameter will be updated, such as by incrementing the previous value.

When a second generation license 620 (and, optionally, its associated content) is transferred 631, 632, 633, 634 (e.g., through a copy) to a different device such as a laptop 635, cell phone 636, 638, or PDA 637, then the e.g., “generation” evolving parameter (such as the parameter value 410 (FIG. 4) is updated to reflect that a 3^{rd} generation copy has been made.

An evolving restriction state value, such as ‘play count’ would be expected to have the same value in both the original license 610 and the copied license 620, as the act of copying will not be expected to change the state value in the original, first generation license even if the user had played the content a number of times. For example, if the license 610 has an evolving restriction “play count,” copying the license would not be expected to modify the state value. However, if the license 610 has an evolving restriction “copy count” indicating the number of times that a hardcopy of the license can be made, some embodiments may consider copying the content to another device a copy, and would thus modify the evolving state value in “copy count” when the content was copied to another device.

### EXAMPLE 8

### Exemplary Evolving Parameter

An exemplary evolving parameter, such as the parameter 410 (FIG. 4) can be a “source” parameter. This parameter has as its value the type of device that created (or copied) the license.

With reference to FIG. 6, at 602, a user at a computer 615 requests content, such as a game, from a license acquisition server 605. The license acquisition server 605 creates a first generation license 610 for the content, including restrictions on transferring the content, such as those described with reference to FIG. 4. This first-generation license 610 has an evolving parameter, e.g., the parameter 401 (FIG. 4) which holds a record of the type of device which created or copied the license 610—a “source” parameter.

In the first generation of the license 610 the source parameter's value may be “license acquisition server” or some equivalent indicating that the license was generated by a license acquisition server. When the PC 615 copies the content and the license 617, 618, 619, each second generation license 620 will have the “source” value “PC” (or equivalent) as the license was derived from a license on a personal computer 615. If, at 619, the PC copied the license to a cell phone 627, when that cell phone copies 633, 634 its version of the content and license 630 to other devices 637, 638, the 3^{rd} generation derived license copied from the cell phone 630 will have the value “cell phone” (or equivalent) in the “source” evolving parameter.

If the laptop 626 copies 631, 632 the same license and content to other devices 635, 636, each of their licenses will have the value “laptop” (or the equivalent) in the “sources” parameter. Thus, the same generation of licenses can, potentially, have different parameter values in different licenses depending upon which device a given copy was received from.

The evolving restrictions, e.g., 415, 420 (FIG. 4) could then include restrictions on content access based on the value in the “source” parameter. An example of such a restriction may be: any license in which the evolving parameter “source” is set to “cell phone” cannot copy that license to any other device, though any license in which the evolving parameter “source” is set to “PC” or “laptop” can copy that license to any other device.

### EXAMPLE 9

### Exemplary Method to Download Parameterized Licenses

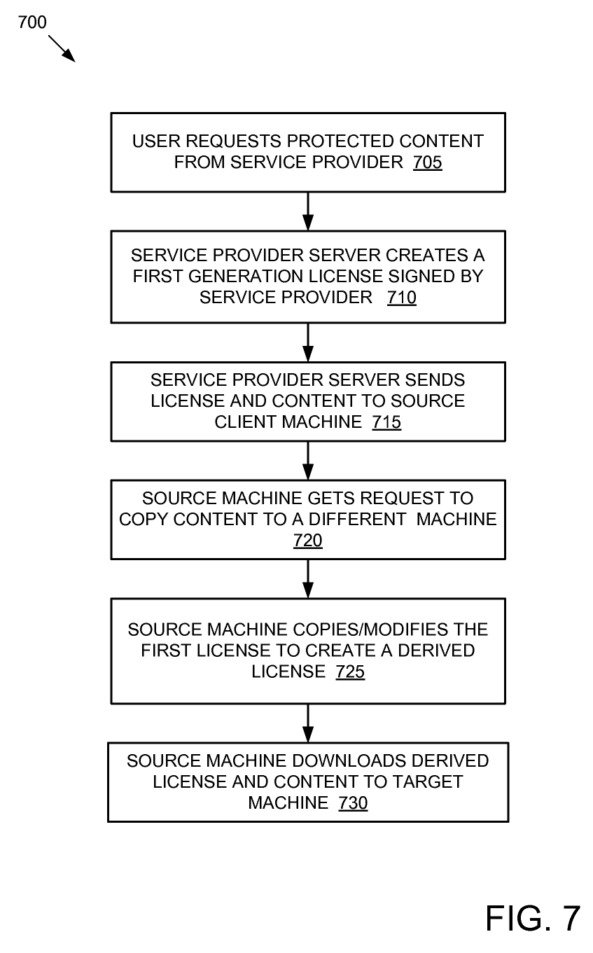

FIG. 7 at 700 shows an exemplary download method using parameterized licenses. This example also references FIG. 6. At 705, a user requests 602 protected content from a service provider. At 710, a license acquisition server 605 at the service provider then constructs a license for the content. This license may be based on previous contractual agreements between the owner of the content and the service provider, may be based on the amount that a user has paid, may be based on a subscription previously purchased by the user, and so on.

This license 610 may have a evolving parameter field 410 (FIG. 4), such as, e.g., “generation” with an initial value, such as the value “1”, or some other understood value, indicating that the content was directly downloaded from a license acquisition server. The license, optionally, also has evolving restrictions for based on evolving parameter values, allowing a device to read and interpret the behavior allowed for the associated content based on the information in the license.

At 715, the license acquisition server 605 then sends 607 the license 610 and, optionally, the content associated with the license, to the user source machine 615. The user can then access the content (e.g., play a downloaded song).

At some point, the user may wish to send the song to a different, target machine, e.g., a laptop 625. In some embodiments, the download process begins 720. At 725, the source machine copies or modifies the license to create a derived license. The modification may comprise updating an evolving parameter.

For example, if the evolving parameter is a “generation” parameter, as discussed above, then license 610 generation restrictions 415, 420 (FIG. 4) may be read to determine if there are copy rights at the current (e.g., 1^{st}) generation. If so, then at 725 the license is copied and modified, e.g., the evolving parameter 410 (FIG. 4), e.g., “generation,” is modified in the copy, such as by increasing by, e.g., “1”, giving the value “2” in the generation field. The original license 610 (in this embodiment) remains the same, e.g., its “generation” parameter is not modified.

In other embodiments, the license restrictions are kept at the device 615. At 730, the source machine 615 downloads 617 the modified license 620 and, optionally, the content to the target machine 625.

At the target machine 625, the DRM system of the target machine, using the license 405, the evolving parameter values 410, and, optionally, the evolving restrictions 415, 420 can determine what rights the user has to access the content. In certain embodiments, the parameter restrictions 415, 420 are not included in the license, but rather are built in to the device logic.

### EXAMPLE 10

### Exemplary Method to Use Parameterized Licenses when Accessing Content

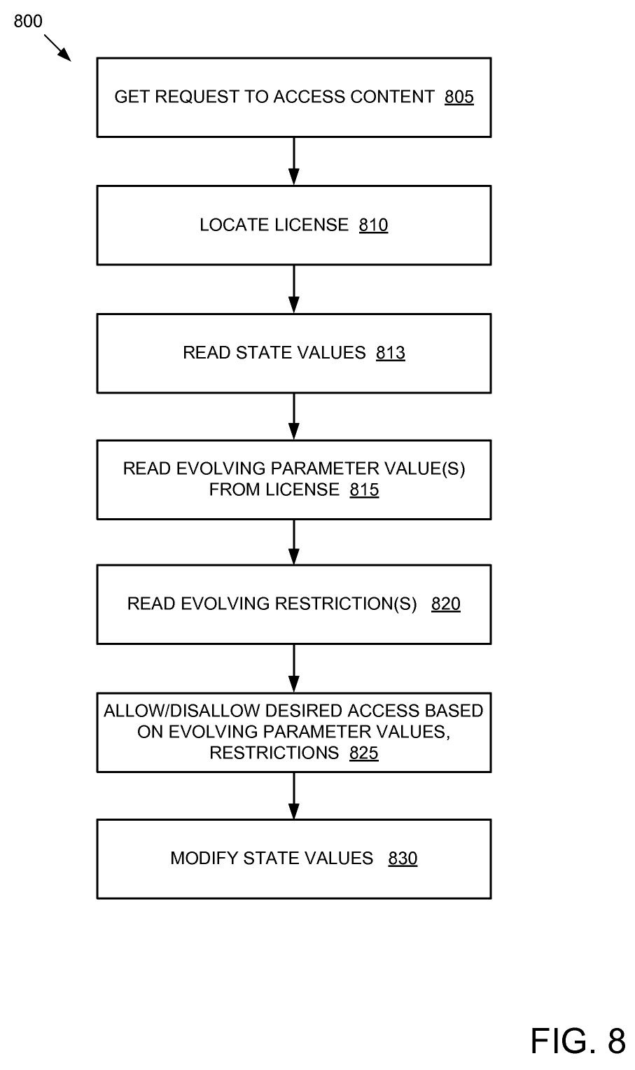

FIG. 8 at 800 shows an exemplary method to use a parameterized license when accessing content at a computing device, such as a PC 615 or a laptop 625 (FIG. 6). At 805, a request to access content is received, by, e.g., the DRM system, or a similar content-license processing system. At 810, the license associated with the content is located. In an alternate embodiment, the license cannot be located on the device itself, so an associated license acquisition server is queried using a network connection, such as the Internet. The license acquisition server may then download an appropriate license.

The individual state values for content on or associated with a given device may be stored within the device itself, e.g., they may be stored (e.g., as part of a DRM system) associated with the device. For example, the DRM may store the number of times a given song has been played. At 813, these state values, if present, are read and updated by, e.g., the DRM system.

At 815, the evolving parameter values, such as the value stored in the parameter 410 (FIG. 4), e.g., a “generation” value, a “source” value, etc., are read by, e.g., the DRM system. At optional 820, in embodiments with evolving restrictions stored in the license, the evolving restrictions are read from the license, such as, e.g., “if evolving parameter ‘generation’ value is less than 3, allow copying.” In systems with evolving restrictions stored in the DRM system, the evolving restrictions are read by the DRM system. Some embodiments may store restrictions at both the license and within the DRM system logic.

At 825, the desired access is either allowed or disallowed based on some combination of the restrictions and parameter values. For example, assume a user has requested that a song be played. Also assume that the song has an associated license with the following values: a “Playcount” parameter with a value of “4”; and a “generation” parameter with a value of “2”. Further, assume that the song has a “number of times played” state on the device associated with it with the value 4, indicating that the song has been played by that device four times. The DRM system can then interpret the “Playcount” restriction in the license to indicate that the song can only be played four times. As the song “Playcount” state is already at “4”, the song will not be played.

For another example, assume that the parameter values in the license are the same, but one of the evolving restrictions is interpreted to read: don't allow play if “generation” is greater than or equal to 3. Here, the song would be allowed to play if the device's associated “number of times played” state is less than 4, but if the value of a generation parameter were 3 or higher, play would not be allowed.

At 830, the state values associated with the content may be modified. These state values may keep track of any of the content permission requests such as play, bum, synch, copy, and so forth. For example, if a song has been allowed to be played, the state value “number of times played” in the song's associated DRM state store may be modified, such as, e.g., incrementing the associated DRM “number of times played” state by one.

### EXAMPLE 11

### Exemplary Parameterized License Access System

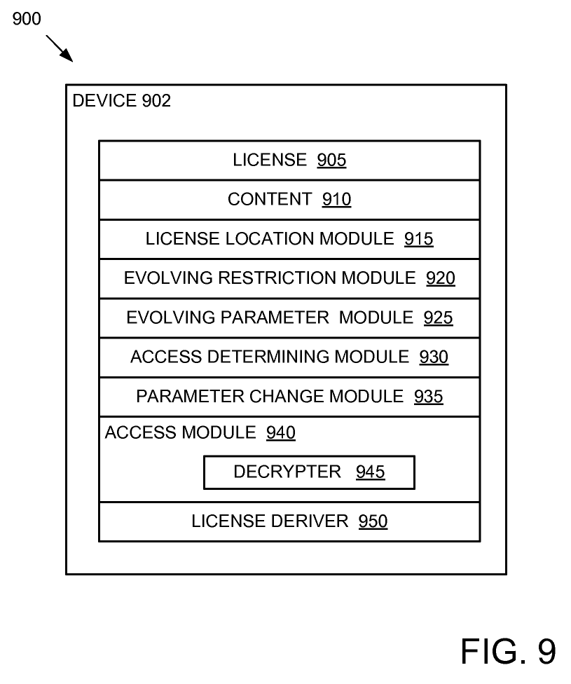

FIG. 9 at 900 shows an exemplary system which can be used to permit or deny access to content within the context of a device which uses digital rights management. Modules within the system may be implemented in software, firmware (software embedded in hardware), hardware, or a combination thereof. Some embodiments implement at least portions of the system within an operating system associated with a computer such as the computing environment 100 (FIG. 1).

Content 910, which may be any of the types of content discussed herein, is stored on a device 902. The content may be encrypted. If encrypted, a publicly-available private encryption/decryption scheme may be used. A license 905 can be associated with the content. In some embodiments, the license was signed by a license acquisition server (e.g., using strong encryption) when the content was downloaded to the device 902. The license may be in the form of the license 400 (FIG. 4). As such, the license is expected to have at least one evolvable parameter 410 (FIG. 4) such as a “generation” number. Some embodiments of the license also have at least one evolvable restriction 415, 420 (FIG. 4) that specifies policy for when and how the content can be accessed based on the values of the evolvable parameter 410 (FIG. 4).

A license location module 915 for locating a license associated with the content may be provided. In some embodiments, the license 905 may be located somewhere other than at the device 902. In such cases, the license location module 915 would be expected to be able to locate the license, within reason. For example, if the license was located at an offsite server and the connection between the device and the server were down, the license location module 915 would not be expected to find the (temporarily unavailable) license.

An evolving restriction module 920 can be used to read and process the policy, such as the restrictions 415, 420 (FIG. 4) associated with a license. If a license includes restrictions and/or parameters that the evolving restriction module cannot interpret, as, e.g., the restrictions and/or parameters are newer than the evolving restriction module, the evolving restriction module may ignore the restrictions. In some embodiments, if the evolving restrictions cannot be understood, access will not be allowed. In some embodiments, the policy may be embodied in conformance rules, may be stored within a DRM system, and so forth. This module may also read content state values associated with the DRM.

An evolving parameter module 925 may be included, or may be a part of the evolving restriction module 920. It can be used to read the value of evolving parameters associated with the license 905 (e.g. 400, FIG. 4). This module could, for example, determine the value of an evolving parameter within the license. This module, in certain embodiments, may also read evolving restrictions (from the license or DRM system) or state values stored in the DRM system.

Once the evolving parameters, evolving restrictions, and the state values are read, and the restrictions are understood (or ignored), then an access determining module 930 can be used to determine what specific access restrictions are allowed for the content 910. For example, if the content is a game, and the evolving parameter is “generation,” the evolving parameter value is “1”, and the evolving restriction is “allow play if generation <4, allow copying if generation <3”; then access is permitted for playing or copying the game. A content access module 940 can be used to allow access, by, e.g., decrypting, if the access determining module 930 allows such access. In certain embodiments, if access is allowed, then a decrypter 945 can decrypt the content, leaving it free to play, copy, etc.

An evolving parameter change module 935 may also be present. This module can be used to update the value of evolving parameters (e.g. 410) in the license 905 depending on content behavior. It may also be used to update state values (e.g., the value of “number of times played,” i.e., the number of times its associated song has been played) associated with the content that may be stored within a DRM system.

A license deriver module 950may also be included. When content is allowed to be copied by, e.g., the access module 940, the license 905 may be derived along with the content from a source (original) onto a target device.

In some implementations, the derived license is sent (optionally, separate from the content) to the target device. The derived license may have had an, e.g., “generation” evolving parameter (e.g. 410) modified, by, e.g., the parameter change module 935, such as by incrementing by “1” (or another appropriate amount) indicating that this license is a derived version of the original license. The derived license can still be (a version of) the original license signed by the original server, not a copy signed by the device, which might employ weaker cryptography.

### EXAMPLE 12

### Exemplary New Rights Addition

In some embodiments, new restrictions (which may be called “extended restrictions”) may be added to a policy. When such new restrictions are created, certain devices that were released prior to the creation of the new restrictions will not understand the restrictions.

With reference to FIG. 6, at 602, a user at a computer 615 requests content, such as a movie, from a license acquisition server 605. The license acquisition server 605 creates a first generation license 610 for the content, including new parameter(s) and restriction(s) (e.g., 415, 420 of FIG. 4) on the content which it then transfers 607 to a primary device 615. The primary device 615 may not understand how to interpret the new restrictions. In some embodiments, the device is agnostic to the new restrictions; that is, they may be ignored, in which case the behavior of the device is not changed. However, the primary device 615 may then transfer 619 the content to another device, such as a cell phone 627. The primary device 615 will then make and send a 2^{nd} generation license to the new device 627 which includes the new parameter(s) and restriction(s). If this new device 627 has an updated DRM system which understands the new parameter(s) and restriction(s) (e.g., 410, 415, 420 in FIG. 4) it will enforce those restrictions. In other cases, devices that do not understand the new restrictions (e.g., the PC 615) will fail the license evaluation and not allow transfer of the content of license 620.

### EXAMPLE 13

### Exemplary Parameterized License Access System

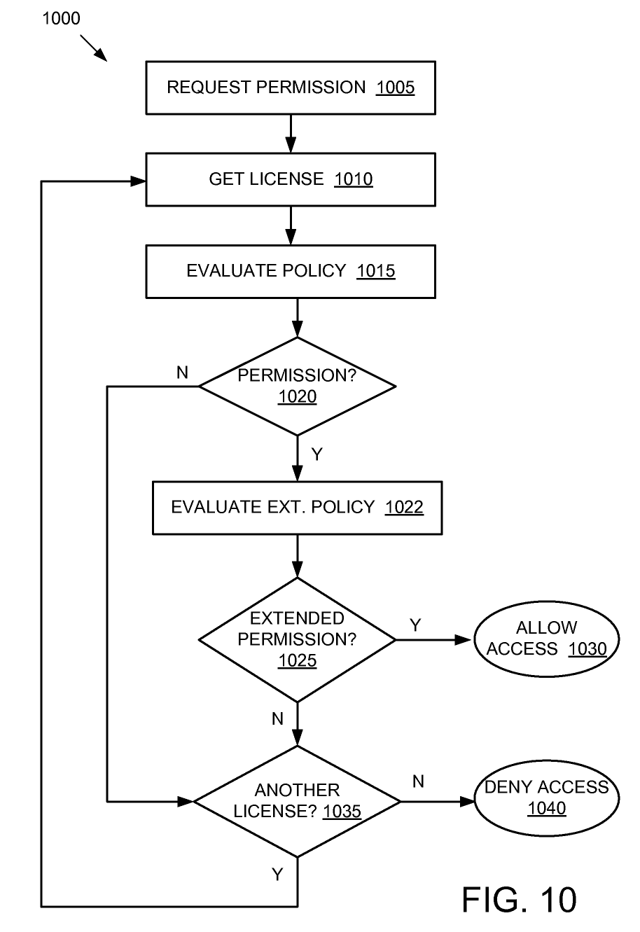

FIG. 10 at 1000 shows a method to determine if content has access rights when there is a complex chain of licenses. At 1005 permission is requested to access content. This permission may come from the user by way of a digital rights management system, and so on. At 1010, a license for the content is found, by, for example, a license location module 915 (FIG. 9). At 1015, the license policy (which may be embodied, at least in part, in parameter(s) 410 (FIG. 4) and/or restrictions 415, 420 of FIG. 4) for the content is evaluated. At 1020, it is determined if the license grants permission to view the data. If not, then at 1035 it is checked if there is another license in the license chain that could be used to grant permission to access the data.

If, at 1020, permission is granted, then at 1022, extended license restrictions are evaluated. This evaluation can use license property values (e.g., state such as the evolving parameter field 410 in FIG. 4, such as a “generation” parameter or a “source” parameter) and evolving restrictions (e.g., 415, 420 in FIG. 4) to determine if the content can be accessed. These may also be new license parameters that only newer devices understand. Older devices may not evaluate the extended license parameters, or may evaluate the license parameters but be unable to understand one or more of the parameters. If parameters are not understood, then, in some embodiments, the unintelligible license parameters are ignored. In other embodiments, the license evaluation fails.

At 1025, it is determined if permission has been granted by the extended restrictions. If so, then at 1030, access will be allowed. The application may then decrypt and use the content, e.g., 910 (FIG. 9).

If permission has not been granted, then at 1035, it is checked if another license in a license chain for the content exists. If there is no other license, then at 1040 access is denied. If there is another license in the license chain, then the method continues at 1010. The license the next level up in the license chain should be checked next.

License with Extensible Restrictions

Table 1 shows a sample license for content with a new extended restriction. Table 2 shows a sample license for content adding a new restriction to an existing right.

TABLE 1
License for content with a new right

Header structure
...
Container Object
|
+--Extensible Policy Rights Object (Optional)
| |
| +--Extensible Policy Restrictions Object (0 or more)
|
+ -- Key Material Container Object
| |
| +-- Content Key Object
|
+-- Signature Object

TABLE 2
License for content with extended restriction added to an existing right
(Playback is one example of a right with an extended restriction)

Header structure
...
Container Object
|
+--Playback Container (Optional)
| |
| +--Extensible Policy Restrictions Object (0 or more)
|
+ -- Key Material Container Object
| |
| +-- Content Key Object
|
+-- Signature Object

In an embodiment, policy is represented as objects inside root container objects. An example of such a root container object is shown in Table 2. Policy attributes are separated into groups, which may include: global attributes, per-right attributes (play, copy), and global supported objects (signatures). These objects may contain two main properties: type and flags. Further, flags may be optional or required. The type field may uniquely identify the type of the object.

### Generation Number Object

An example of an evolving parameter is “generation,” which contains the number of the generation of the object. Table 3 shows an implementation of the generation object in a license. When a license is derived from an existing license, in an exemplary embodiment, the DRM system sets the value of the generation number in the derived license to one greater than in the existing license. This container can be a child of the “outer container” object shown in Table 2.

TABLE 3
Generation Number Object

| | Field | Size | | |
|---|---|---|---|---|
| Field Name | Type | (bits) | Value | Notes |
| Object Type | WORD | 16 | TBD | Defined per spec for |
| | | | | Extensible Rights Object |
| Object Length | DWORD | 32 | Varies | Length includes this |
| | | | | object's 8 bytes. |
| Generation | DWORD | 32 | Varies | Defines the generation |
| Number | | | | number of the license. |

### Indirect License Acquisition

Extensible policy objects are copied from the existing license, in their entirety, in some embodiments, into the derived license. During license derivation, the PC or other consumer device may increment the “generation” evolving parameter in the derived license; may modify the “source” evolving parameter to reflect the type of machine that made the derived license, and so forth.

### EXAMPLE 14

### Exemplary Alternate Embodiments

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-enabled method for automatically updating digital rights management licenses associated with content comprising:
creating a first license associated with the content;
creating an evolving parameter in the first license;
creating at least one evolving restriction to be interpreted based on the value of the evolving parameter;
sending the first license to a first user device; and
updating a value associated with the evolving parameter in the first license.

2. The method of claim 1 wherein the at least one evolving parameter comprises generation of the first license.

3. The method of claim 1 wherein the at least one evolving restriction is located in the first license.

4. The method of claim 1 wherein the at least one evolving restriction is located in the first user device.

5. The method of claim 1 further comprising allowing access to the content based on a value of the evolving parameter in the first license and the at least one evolving restriction.

6. The method of claim 1 wherein the first user device ignores the at least one evolving restriction.

7. The method of claim 1 further comprising in connection with copying the content to a second device, creating a second license by copying the first license and updating, in the second license, a value associated with the evolving parameter of the first license.

8. The method of claim 7 further comprising copying the second license with the updated value to the second device and wherein updating the value in the evolving parameter comprises updating a source parameter to hold type of the first device.

9. The method of claim 1 wherein updating the value associated with the evolving parameter comprises modifying a generation evolving parameter value or a source evolving parameter value.

10. The method of claim 1 wherein the at least one evolving restriction is in the first license.

11. A computer-readable medium having computer-executable instructions encoded thereon for performing the method recited in claim 1.

12. A computer-enabled method to access content in a computer-enabled device with digital rights management comprising:
receiving a request to access content;
locating a license associated with the content, the license comprising at least one evolving parameter with a value;
using at least one evolving restriction and the at least one evolving parameter value determine if content access is allowed;
if content access is allowed, then allowing content to be accessed; and
modifying the at least one evolving parameter value.

13. The computer-enabled method of claim 12 wherein the at least one evolving parameter with a value is a generation evolving parameter.

14. The computer-enabled method of claim 12 wherein the parameter is a generation parameter, wherein the license is copied to a second device from a first device, and wherein the generation evolving parameter value in the copied license is modified such that the at least one evolving restriction is interpreted differently by the second device than by the first device.

15. The computer-enabled method of claim 12 wherein the at least one evolving restriction is hard-coded into the device.

16. A computer-implemented system for using parameterized licenses to allow content access on a user device comprising:
a license location module for locating a license associated with the content;
an evolving parameter module for reading the value of a parameter associated with the license;
an evolving restriction module for reading at least one restriction associated with the parameter;
an access determining module for determining, based on the evolving parameter value and evolving restriction, if the content can be accessed;
a content access module for allowing access; and
a parameter change module for updating the evolving parameter value based upon access allowed.

17. The computer-implemented system of claim 16 wherein the evolving restriction module reads the evolving restriction from the license associated with the content.

18. The computer-implemented system of claim 16 wherein the access is copying the content and wherein the system further comprises the license deriver module operationally able to copy the license, and operationally able to send the derived license to a second device.

19. The computer-implemented system of claim 18 wherein the license deriver module is operationally able to use the evolving parameter module to update a generation parameter value.

20. The computer-implemented system of claim 18 wherein the license deriver module is operationally able to use the evolving parameter module to update a source parameter value.
